(19) United States
(12) Patent Application Publication
(10) Pub. No.: US 2008/0306940 A1
(43) Pub. Date: Dec. 11, 2008

(54) IMAGE DISPLAY DEVICE AND METHOD

(75) Inventors: Xiao-Guang Li, Shenzhen (CN); Han-Che Wang, Shenzhen (CN); Li Wang, Shenzhen (CN); Hua-Dong Cheng, Shenzhen (CN); Shin-Hong Chung, Shenzhen (CN); Chun-Wei Pan, Shenzhen (CN)

Correspondence Address: NORTH AMERICA INTELLECTUAL PROPERTY CORPORATION, P.O. BOX 506, MERRIFIELD, VA, 22116, US

(73) Assignees: HONG FU JIN PRECISION INDUSTRY (Shen Zhen) CO., LTD., Shenzhen City (CN); HON HAI PRECISION INDUSTRY CO., LTD., Taipei Hsien (TW)

(21) Appl. No.: 12/134,225

(22) Filed: Jun. 6, 2008

(30) Foreign Application Priority Data
Jun. 8, 2007 (CN) 200710074769.8

(51) Int. Cl. G06F 7/06; G06F 3/048; G06F 17/30

(52) U.S. Cl. 707/5; 715/841; 715/803; 707/102; 707/E17.005; 707/E17.017

(57) ABSTRACT

An image display device is provided. The device includes a display screen, a storage unit, and a processing unit. The storage unit stores images and selection interface information. The selection interface information includes a plurality of catalogues each of which collects one or more images. The processing unit includes a selection interface display module, a selection control module, and an image search module. The selection interface display module controls the display screen to display a selection interface that provides the catalogues for selection according to the selection interface information. The selection control module generates a selection signal in response to a selection operation on the selection interface. The selection signal indicates which catalogue on the selection interface is selected. The image search module searches the storage unit for the images according to the selection signal. An image display method is also provided.

### BACKGROUND

1. Technical Field

The present invention relates to image display devices, and particularly to an image display device and method capable of effectively and quickly obtain desired photos.

2. General Background

Digital photos are ubiquitous and digital cameras are becoming more widespread. Digital photos may be viewed on the display screen of a digital camera or they can be printed or uploaded to a computer and displayed on the computer screen.

Printed digital photos require digital photographic printers, photographic papers, and color ink for color photos. The cost of photographic papers and color ink are related to the number of prints. Printed photos are framed and can be hung from walls or placed on top of desks or tables. Because photographic frames typically hold a single photo, not many photos will actually be framed and displayed. Storing digital photos on computer hard drives and displaying them on computer screens is cheaper than framing. However it is not convenient to show photos on computer screens because computers are bulky devices and it may not be convenient for viewers to carry a computer everywhere they go. To overcome the problem of carrying computers to display photographs, digital photo frames are now being used.

A digital photo frame looks like a traditional photo frame. Typical digital photo frames include built-in memory storage and provisions for accepting external memory cards. Thus, one digital photo frame is capable of displaying more than one digital photo, which is stored in the internal memory or on memory cards attached to the digital photo frame.

To display a specific photo stored (internal or external) in a digital photo frame, the photos can be viewed sequentially until the desired photo is viewed or one can select photos at random and hope to hit the specific photo. In this situation, considerable time may be spent searching through the digital photo album. In addition, when searching for a photo taken on the same date or same in the location, considerable time is spend in searching through the digital photos in memory.

What is needed, therefore, is an improved image display device and method that can effectively and quickly obtain desired photos.

### SUMMARY

An image display device is provided. The device includes a display screen, an input unit, a storage unit, and a processing unit. The input unit is configured for receiving a selection operation. The storage unit is configured for storing images and selection interface information, wherein the selection interface information includes a plurality of catalogues each of which collects one or more images. The processing unit includes a selection interface display module, a selection control module, an image search module, and an image display control module. The selection interface display module is configured for reading the selection interface information from the storage unit and controlling the display screen to display a selection interface that provides the catalogues for selection. The selection control module is configured for generating a selection signal in response to the selection operation, wherein the selection signal indicates which catalogue on the selection interface is selected. The image search module is configured for searching the storage unit for the images according to the selection signal. The image display control module is configured for controlling the display screen to display the searched images.

An image display method is also provided. The method includes: (a) providing a storage unit configured for storing images and selection interface information, the selection interface information including a plurality of catalogues each of which collects one or more images; (b) displaying a selection interface according to the selection interface information, wherein the selection interface provides the catalogues for selection; (c) generating a selection signal in response to a selection operation on the selection interface, wherein the selection signal indicates which catalogue on the selection interface is selected; (d) searching the storage unit for the images according to the selection signal; and (e) displaying the searched images.

Other advantages and novel features will be drawn from the following detailed description with reference to the attached drawing.

### BRIEF DESCRIPTION OF THE DRAWINGS

The components of the drawings are not necessarily drawn to measuring scale, the emphasis instead being placed upon clearly illustrating the principles of the image display device. Moreover, in the drawings, like reference numerals designate corresponding parts throughout the several views.

FIG. 1 is a schematic diagram of a hardware infrastructure of an image display device according to an exemplary embodiment of the present invention.

FIG. 2 is a schematic diagram illustrating a display state of the image display device of FIG. 1 according to a first exemplary embodiment of the present invention.

FIG. 3 is a schematic diagram illustrating a table which records relationships between images and locations where the images belong to.

FIG. 4 is a schematic diagram illustrating another display state of the image display device of FIG. 1 according to a second exemplary embodiment of the present invention.

FIG. 5 is a schematic diagram illustrating the image display device displays images thereon according to an exemplary embodiment of the present invention.

FIG. 6 is a flowchart of an image display method implemented by the image display device of FIG. 1.

### DETAILED DESCRIPTION OF THE EMBODIMENT

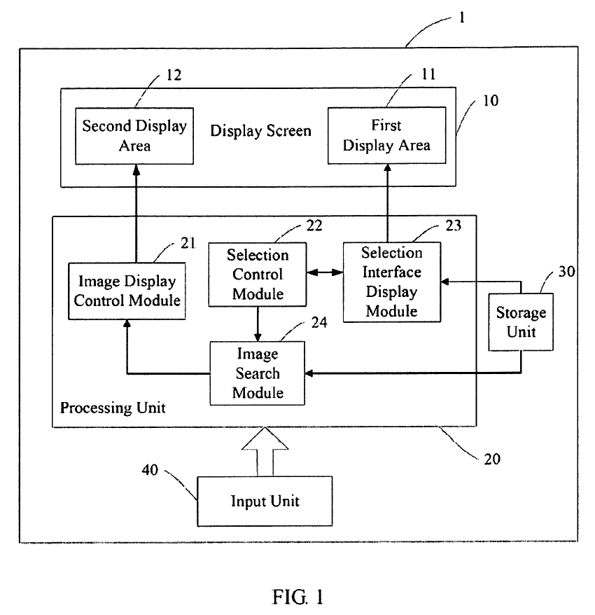

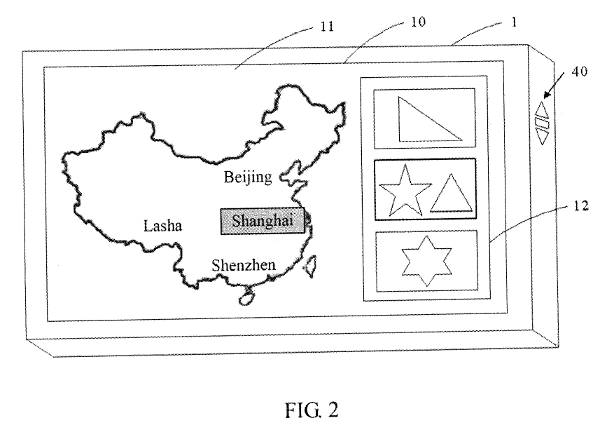

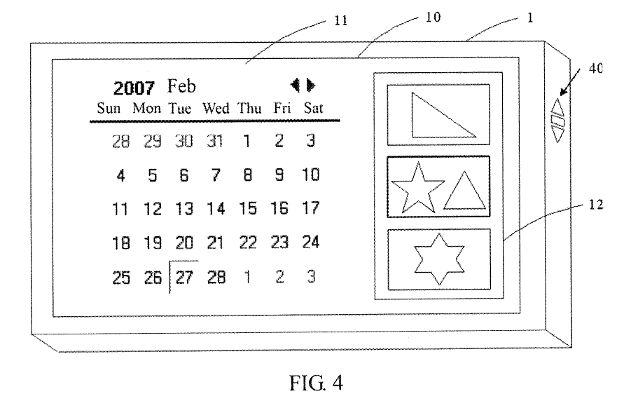

FIG. 1 is a schematic diagram of a hardware infrastructure of an image display device according to an exemplary embodiment of the present invention. The image display device 1 includes a display screen 10, a processing unit 20, a storage unit 30, and an input unit 40. The input unit 40 is configured for receiving a selection operation. Referring to FIGS. 2 and 4, the display screen 10 is divided into a first display area 11 and a second display area 12. The first display area 11 is on the left of the display screen 10, while the second display area 12 is on the right of the display screen 10. However, it should be noted that positions of these two display areas can be arranged differently and is not limited to the arrangement as described. The size of the first display area 11 is preferably larger than that of the second display area 12.

The storage unit 30 is configured for storing images and selection interface information. The selection interface information includes a plurality of catalogues, each of which collects one or more images. The selection interface information can be assigned with different contents and thus to provide different selection interfaces. For example, in a first exemplary embodiment as shown in FIG. 2, the selection interface information is geographical map information and the selection interface is a map selection interface allowing a desired location to be selected. Each location in the map selection interface is associated with one of the catalogues. In a second exemplary embodiment as shown in FIG. 4, the selection interface information is calendar information and the selection interface is a calendar selection interface allowing a desired date to be selected. Each date in the calendar selection interface is associated with one of the catalogues.

The processing unit 20 includes an image display control module 21, a selection control module 22, a selection interface display module 23, and an image search module 24.

The selection interface display module 22 is configured for reading the selection interface information from the storage unit 30 and controlling the display screen 10 to display the selection interface on the first display area 11 such as that shown in FIGS. 2 and 4. Through the selection interface and the input unit 40, a user can select a desire catalogue corresponding to a location or a date in the selection interface.

The selection control module 22 is configured for generating a selection signal in response to a selection operation on the selection interface through the input unit 40, wherein the selection signal indicates which catalogue on the selection interface is selected. The selection control module 22 is further configured for transmitting the selection signal to the selection interface display module 23 and the image search module 24.

The selection interface display module 23 is configured for highlighting the selected catalogue on the selection interface when receiving the selection signal.

The image search module 24 is configured for searching the storage unit 30 for the images agreeing with the selection signal.

The image display control module 21 is configured for controlling the display screen 10 to display the searched images on the second display area 12. The second display area 12 can display one or more images thereon according to the user's preference. When the second display area 12 cannot accommodate all the searched images one time, the input unit 40 is operable to scroll the images displayed on the second display area 12.

FIG. 2 is a schematic diagram illustrating a display state of the image display device of FIG. 1 according to a first exemplary embodiment of the present invention. In the first exemplary embodiment, the selection interface information in the storage unit 30 is geographical map information. The selection interface display module 23 reads the geographical map information from the storage unit 30, and controls the display screen 10 to display a map selection interface such as that shown in FIG. 2 on the first display area 11. The map selection interface provides at least one location for selection.

When receiving the selection operation on the selection interface, the selection control module 22 generates the selection signal indicative of which catalogue (i.e., location) on the selection interface is selected, and transmits the selection signal to the selection interface display module 23 and the image search module 24. The selection interface display module 23 highlights the selected location (e.g., “Shanghai”) on the selection interface according to the selection signal. The image search module 24 searches the storage unit 30 for the image of the selected location indicated by the selection signal.

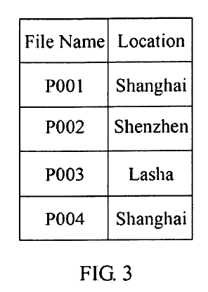

Regarding search method utilized by the image search module 24, there are two search methods provided. In the first search method, the storage unit 30 provides a plurality of file folders, each of which is associated with a corresponding identified location and is configured for storing the images belonging to the identified location. The image search module 24 searches the storage unit 30 of the file folder agreeing with the selected location. In the second search method, the storage unit 30 provides a table such as that shown in FIG. 3 for recording a relationship between the images and locations where the images belong to. The image search module 24 searches the storage unit 30 for the table of the images agreeing with the selected location.

FIG. 4 is a schematic diagram illustrating another display state of the image display device of FIG. 1 according to a second exemplary embodiment of the present invention. In the second exemplary embodiment, the selection interface information is calendar information. The selection interface display module 23 reads the calendar information from the storage unit 30, controls the display screen 10 to display a calendar selection interface such as that shown in FIG. 4 on the first display area 11.

When receiving the selection operation on the selection interface, the selection control module 22 generates the selection signal indicative of which catalogue (i.e., date) on the selection interface is selected, and transmits the selection signal to the selection interface display module 23 and the image search module 24. The selection interface display module 23 highlights the selected date (e.g., “27”) on the selection interface according to the selection signal. The image search module 24 searches the storage unit 30 for the images agreeing with the selected date indicated by the selection signal, wherein the search method utilized herein is the same as that described in the first exemplary embodiment.

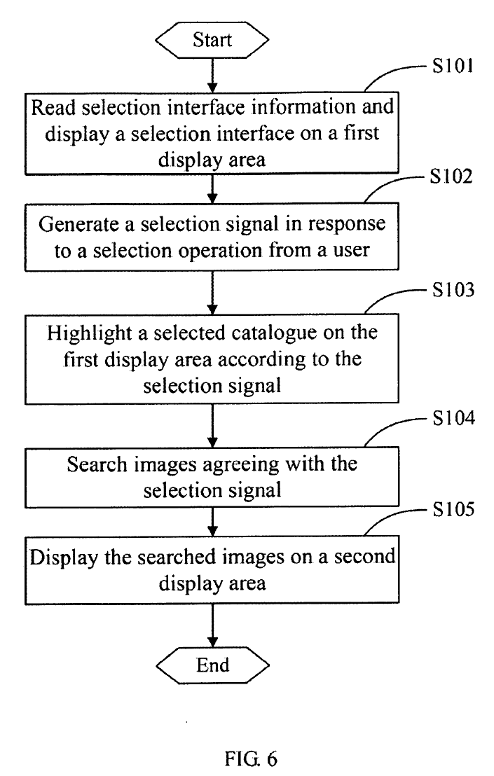

FIG. 6 is a flowchart of an image display method implemented by the image display device of FIG. 1. In step S101, the selection interface display module 23 reads the selection information from the storage unit 30, and controls the display screen 10 to display the selection interface on the first display area 11.

In step S102, the selection control module 22 generates the selection signal, in response to the selection operation inputted through the input unit 40, and transmits the selection signal to the selection interface display module 23 and the image search module 24.

In step S103, the selection interface display module 23 highlights the selected catalogue on the selection interface according to the selection signal.

In step S104, the image search module 24 searches the storage unit 30 for the images agreeing with the selection signal.

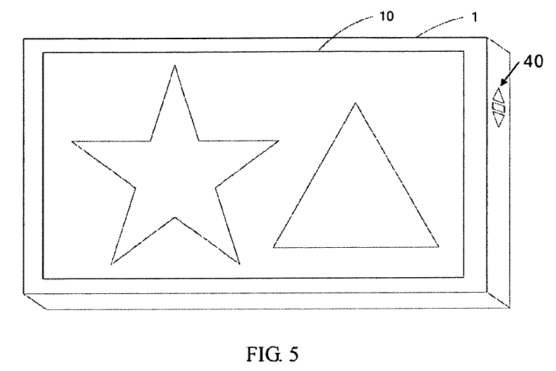

In step S105, the image display control module 21 displays the searched images on the second display area 12 such as that shown in FIG. 2 or 4, or on the whole display screen 10 such as that shown in FIG. 5.

Although the present invention has been specifically described on the basis of preferred embodiments and preferred method thereof, the invention is not to be construed as being limited thereto. Various changes or modifications may be made to the embodiments and method without departing from the scope and spirit of the invention.

What is claimed is:

1. An image display device comprising:
a display screen;
an input unit configured for receiving a selection operation;
a storage unit configured for storing images and selection interface information,
wherein the selection interface information comprises a plurality of catalogues each of which collects one or more images;
a processing unit comprising:
a selection interface display module configured for reading the selection interface information from the storage unit and controlling the display screen to display a selection interface which provides the catalogues for selection;
a selection control module configured for generating a selection signal in response to the selection operation from the input unit, wherein the selection signal indicates which catalogue on the selection interface is selected;
an image search module configured for searching the storage unit for the images according to the selection signal; and
an image display control module configured for controlling the display screen to display the searched images.

2. The image display device according to claim 1, wherein the selection interface information is calendar information, and each of the catalogues is associated with an identified date.

3. The image display device according to claim 2, wherein the storage unit provides a plurality of file folders, each of the file folders is associated with a corresponding identified date and is configured for storing the images belong to the identified date, the selection signal indicates which date on the selection interface is selected, and the image search module searches the storage unit for the file folder according to the selected date.

4. The image display device according to claim 2, wherein the storage unit provides a table for recording a relationship between the images and the dates of the images, the selection signal indicates which date on the selection interface is selected, and the image search module searches the table for the images according to the selected date.

5. The image display device according to claim 1, wherein the selection interface information is geographical map information, and each of the catalogues is associated with an identified location.

6. The image display device according to claim 5, wherein the storage unit provides a plurality of file folders, each of the file folders is associated with a corresponding identified location and is configured for storing the images belong to the identified location, the selection signal indicates which location on the selection interface is selected, and the image search module searches the storage unit for the file folder according to the selected location.

7. The image display device according to claim 5, wherein the storage unit provides a table for recording a relationship between the images and locations where the images belong to, the selection signal indicates which location on the selection interface is selected, and the image search module searches the table for the images according to the selected location.

8. The image display device according to claim 1, wherein the display screen comprises a first display area and a second display area, the selection interface display module controls the display screen to display the selection interface on the first display area, and the image display control module controls the display screen to display the searched images on the second display area.

9. An image display method used in an image display device, the image display method comprising:
providing a storage unit configured for storing images and selection interface information, the selection interface information comprising a plurality of catalogues each of which collects one or more images;
displaying a selection interface according to the selection interface information, wherein the selection interface provides the catalogues for selection;
generating a selection signal in response to a selection operation on the selection interface, wherein the selection signal indicates which catalogue on the selection interface is selected;
searching the storage unit for the images according to the selection signal; and
displaying the searched images.

10. The method according to claim 9, wherein the selection interface information is calendar information, and each of the catalogues is associated with an identified date.

11. The method according to claim 10, further comprising providing a plurality of file folders in the storage unit, each of the file folders is associated with a corresponding identified date and is configured for storing the images belong to the identified date.

12. The method according to claim 11, wherein the selection signal indicates which date on the selection interface is selected, and the searching step further comprises searching the storage unit for the file folder according to the selected date.

13. The method according to claim 10, further comprising providing a table for recording a relationship between the images and dates which the images belong to.

14. The method according to claim 13, wherein the selection signal indicates which date on the selection interface is selected, and the searching step further comprises searching the table for the images according to the selected date.

15. The method according to claim 9, wherein the selection interface information is geographical map information, and each of the catalogues is associated with an identified location.

16. The method according to claim 15, further comprising providing a plurality of file folders, each of the file folders is associated with a corresponding identified location and is configured for storing the images belonging to the identified location.

17. The method according to claim 16, wherein the selection signal indicated which location on the selection interface is selected, and the searching step further comprises searching the storage unit for the file folder according to the selected location.

18. The method according to claim 15, further comprising providing a table for recording a relationship between the images and locations where the images belong to.

19. The method according to claim 18, wherein the selection signal indicated which location on the selection interface is selected, and the searching step further comprises searching the table for the images according to the selected location.

20. The method according to claim 9, wherein the displaying step further comprises:
displaying the selection interface on a first display area; and
displaying the searched images on a second display area.
